(19) United States
(12) Patent Application Publication
(10) Pub. No.: US 2017/0192882 A1
(43) Pub. Date: Jul. 6, 2017

(54) METHOD AND SYSTEM FOR AUTOMATICALLY GENERATING A PLURALITY OF TEST CASES FOR AN IT ENABLED APPLICATION

(71) Applicant: HCL Technologies Limited, Uttar Pradesh (IN)

(72) Inventors: Padmajaya BHAGAVATHIAMMAL, Chennai (IN); Logeswari RENGARAJU, Chennai (IN); Jaiganesh DEVARAJULU, Chennai (IN); Hareendran M, Chennai (IN)

(21) Appl. No.: 15/399,493

(22) Filed: Jan. 5, 2017

(30) Foreign Application Priority Data
Jan. 6, 2016 (IN) 201611000515

(51) Int. Cl. G06F 11/36; G06F 17/30

(52) U.S. Cl. CPC G06F 11/3684; G06F 17/30896

(57) ABSTRACT

Disclosed is a system for automatically generating a plurality of test cases for an IT enabled application. The system captures information including a plurality of labels, a plurality of test datasets and a plurality of actions performed by a user on each of a plurality of DOM elements. The system further analyzes the information in order to categorize the information into a plurality of parameters associated to each DOM element. The system further maps an action performed by the user, on a DOM element of the plurality of DOM elements, a label and a test dataset with the DOM element. The system further retrieves one or more keywords mapped to the label in a pre-configured keyword repository. The system further generates a test case based on the one or more keywords, the label, the test dataset and the action performed by the user on the DOM element.

### PRIORITY INFORMATION

The present application claims priority from Indian Patent Application No. 201611000515, filed on Jan. 6, 2016, the entirety of which is hereby incorporated by reference.

### TECHNICAL FIELD

The present subject matter described herein, in general, relates to, automatically generate a plurality of test cases for an Information Technology (IT) enabled application.

### BACKGROUND

Testing has always been in the core of a software product or an Information Technology (IT) application development lifecycle and has always been a highly focused phase in any IT organization. It has been noted that the traditional process for creating test cases is manual and requires significant lead time before testing can be performed on the IT application or the software product. Some of the key challenges that are faced while creating the test cases may include:

A lot of effort and time is consumed in creating the test cases from scratch. This becomes more cumbersome when there are a lot of combinations (of Operating Systems, Platforms, Browsers, multiple versions of environment) where the product or application has to be tested. In addition, not all possible test cases are captured during the initial testing phase. This leads to many field defects in production or defects captured towards the final stage of release of the IT application or software product yielding to a poor quality of the product being developed. Further, the huge volume of similar test cases frustrates the testers and end up missing some critical functional areas.

In order to overcome the aforementioned challenges, IT organizations have started taking lots of steps to improve the quality, optimize on cost and time while meeting the objective of faster delivery of the product in the market. Irrespective of the types of testing (Automated or Manual-Functional or Non Functional) the need of the test cases has always been a key objective in any IT organization. However one of the challenges in the current dynamic, competitive and agile world is “Time”. Understanding the requirements, writing test scenarios, cases and getting it reviewed by Product Managers or Business Analysts has by itself been a time consuming effort and thus proving to be a hiccup in delivering a quality product faster to market. Therefore, based on the above, it may be noted that the most extensive effort in the release of any IT enabled application or product is to create test cases.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to systems and methods for automatically generating a plurality of test cases for an IT enabled application and the concepts are further described below in the detailed description. This summary is not intended to identify essential features of the claimed subject matter nor is it intended for use in determining or limiting the scope of the claimed subject matter.

In one implementation, a system for automatically generating a plurality of test cases for an IT enabled application is disclosed. In one aspect, the system may comprise a processor and a memory coupled to the processor. The processor may execute a plurality of modules stored in the memory. The plurality of modules may comprise a UI and event capturing module, a UI and event analyzer module, a mapper module, a keyword mapper module, and a test case generator module. The UI and event capturing module may capture information, pertaining to a plurality of Document Object Model (DOM) elements, including a plurality of labels, a plurality of test datasets and a plurality of actions performed by a user on each of the plurality of DOM elements. In one aspect, the plurality of DOM elements and the plurality of labels may be present on a web-page of an IT enabled application. The UI and event analyzer module may analyze the information in order to categorize the information into a plurality of parameters associated to each DOM element. The mapper module may map an action performed by the user, on a DOM element of the plurality of DOM elements, a label and a test dataset with the DOM element. The keyword mapper module may retrieve one or more keywords mapped to the label in a pre-configured keyword repository. The test case generator module may generate a test case based on the one or more keywords, the label, the test dataset and the action performed by the user on the DOM element thereby generating the test case for the IT enabled application.

In another implementation, a method for automatically generating a plurality of test cases for an IT enabled application is disclosed. In order to automatically generate the plurality of test cases, initially, information, pertaining to a plurality of Document Object Model (DOM) elements may be captured. In one aspect, the information may comprise a plurality of labels, a plurality of test datasets and a plurality of actions performed by a user on each of the plurality of DOM elements. In one aspect, the plurality of DOM elements and the plurality of labels may be present on a web-page of an IT enabled application. Upon capturing, the information may be analyzed in order to categorize the information into a plurality of parameters associated to each DOM element. Subsequent to the categorization of the information, an action performed by the user, on a DOM element of the plurality of DOM elements, a label and a test dataset may be mapped with the DOM element. After mapping, one or more keywords mapped to the label in a pre-configured keyword repository may be retrieved. After the retrieval of the one or more keywords, test case may be generated based on the one or more keywords, the label, the test dataset and the action performed by the user on the DOM element thereby generating the test case for the IT enabled application. In one aspect, the aforementioned method for automatically generating a plurality of test cases for an IT enabled application may be performed by a processor using programmed instructions stored in the memory.

In yet another implementation, non-transitory computer readable medium embodying a program executable in a computing device for automatically generating a plurality of test cases for an IT enabled application is disclosed. The program may comprise a program code for capturing information, pertaining to a plurality of Document Object Model (DOM) elements, including a plurality of labels, a plurality of test datasets and a plurality of actions performed by a user on each of the plurality of DOM elements, wherein the plurality of DOM elements and the plurality of labels are present on a web-page of an IT enabled application. The program may further comprise a program code for analyzing the information in order to categorize the information into a plurality of parameters associated to each DOM element. The program may further comprise a program code for mapping an action performed by the user, on a DOM element of the plurality of DOM elements, a label and a test dataset with the DOM element. The program may further comprise a program code for retrieving one or more keywords mapped to the label in a pre-configured keyword repository. The program may further comprise a program code for generating a test case based on the one or more keywords, the label, the test dataset and the action performed by the user on the DOM element thereby generating the test case for the IT enabled application.

### BRIEF DESCRIPTION OF THE DRAWINGS

The foregoing detailed description of embodiments is better understood when read in conjunction with the appended drawings. For the purpose of illustrating the disclosure, example constructions of the disclosure is shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for automatically generating a plurality of test cases for an IT enabled application, in accordance with an embodiment of the present subject matter.

FIG. 2 illustrates the system, in accordance with an embodiment of the present subject matter.

FIG. 3 illustrates functional block diagram of the system, in accordance with an embodiment of the present subject matter.

FIG. 4 illustrates a method for automatically generating the plurality of test cases for the IT enabled application, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

It is to be noted that, the most extensive effort in order to perform testing of an IT enabled application or a software solution, before the deployment, is to generate test cases pertaining to the software. Considering the importance of having an enriched test repository and also the need of delivering products or applications faster in the market, the present invention discloses a method and system to automatically generate test cases for testing the IT enabled application before deployment. As and when functionalities or modules of the IT application are developed in atomic parts, the present invention facilitates to automatically generate a set of test cases with a click of a button. It may be understood that the test cases may be generated by a Developer, a Business Analyst, a functional expert, or a manual tester performing ad-hoc gorilla testing with all possible negative and positive scenarios. By automatically generating the test cases, the burden of creating a repository of test cases is taken away from at least one of the Developer, the Business Analyst, the functional expert, or the manual tester. This ensures a good saving in time and effort of the at least one of the Developer, the Business Analyst, the functional expert, or the manual tester along the product development life cycle.

In order to automatically generate the test cases, the present invention captures information, pertaining to a plurality of Document Object Model (DOM) elements. In one aspect, the information may comprise a plurality of labels, a plurality of test datasets and a plurality of actions performed by a user on each of the plurality of DOM elements. In one aspect, the plurality of DOM elements and the plurality of labels may be present on a web-page of an IT enabled application. Upon capturing, the information may be analyzed in order to categorize the information into a plurality of parameters associated to each DOM element. Subsequent to the categorization of the information, an action performed by the user, on a DOM element of the plurality of DOM elements, a label and a test dataset may be mapped with the DOM element. After mapping, one or more keywords mapped to the label in a pre-configured keyword repository may be retrieved. After the retrieval of the one or more keywords, a test case may be generated based on the one or more keywords, the label, the test dataset and the action performed by the user on the DOM element thereby generating the plurality of test cases for the IT enabled application. In one aspect, the plurality of test cases generated is optimized to remove redundant test cases from the plurality of test cases thereby creating an optimized test case repository storing a plurality of optimized test cases.

While aspects of described system and method for automatically generating the plurality of test cases for the IT enabled application and may be implemented in any number of different computing systems, environments, and/or configurations, the embodiments are described in the context of the following exemplary system.

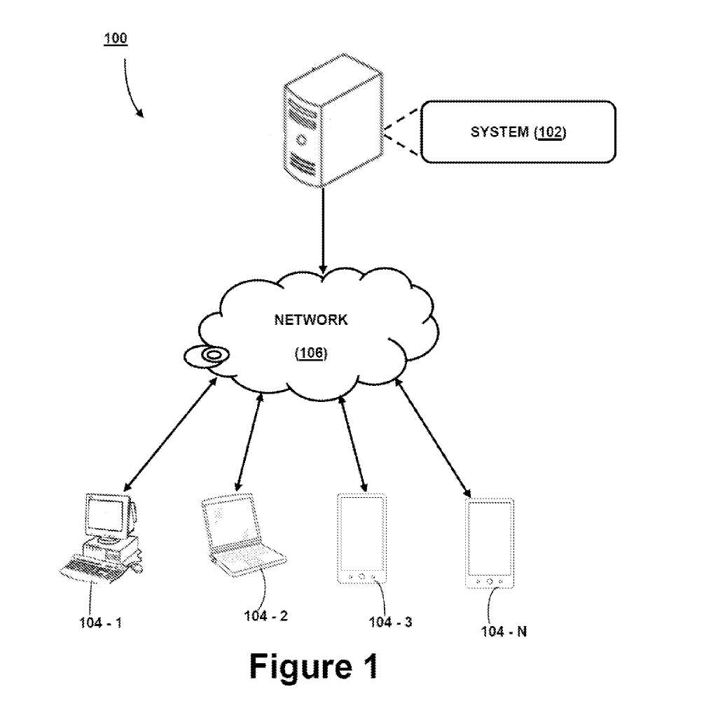

Referring now to FIG. 1, a network implementation 100 of a system 102 for automatically generating a plurality of test cases for an IT enabled application is disclosed. In order to automatically generate the plurality of test cases, initially, the system 102 captures information, pertaining to a plurality of Document Object Model (DOM) elements. In one aspect, the information may comprise a plurality of labels, a plurality of test datasets and a plurality of actions performed by a user on each of the plurality of DOM elements. In one aspect, the plurality of DOM elements and the plurality of labels may be present on a web-page of an IT enabled application. Upon capturing, the system 102 analyzes the information in order to categorize the information into a plurality of parameters associated to each DOM element. Subsequent to the categorization of the information, the system 102 maps an action performed by the user, on a DOM element of the plurality of DOM elements, a label and a test dataset with the DOM element. After mapping, the system 102 maps one or more keywords to the label in a pre-configured keyword repository may be retrieved. Subsequent to the retrieval of the one or more keywords, the system 102 generates a test case based on the one or more keywords, the label, the test dataset and the action performed by the user on the DOM element thereby generating the test case for the IT enabled application.

Although the present disclosure is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment. It will be understood that the system 102 may communicate with one or more communication devices 104-1, 104-2 . . . 104-N. In one implementation, the system 102 may comprise the cloud-based computing environment in which a user may operate individual computing systems configured to execute remotely located applications. Examples of the communication devices 104 may include, but are not limited to, a portable computer, a personal digital assistant, a handheld device, and a workstation. The communication devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

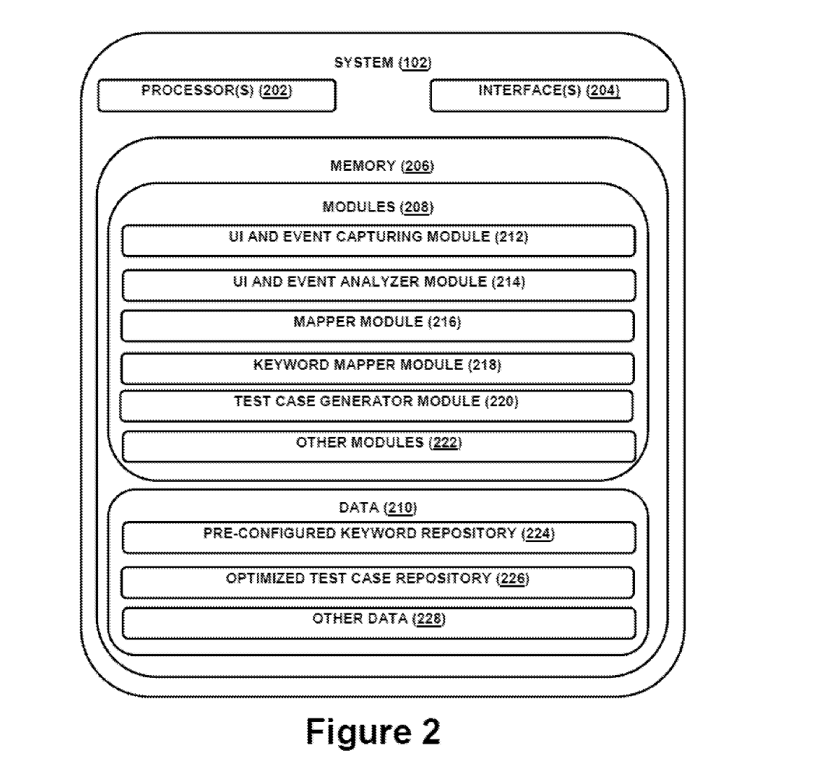

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a UI and event capturing module 212, a UI and event analyzer module 214, a mapper module 216, a keyword mapper module 218, a test case generator module 220, and other modules 222. The other modules 222 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a pre-configured keyword repository 224, an optimized test case repository 226, and other data 228. The other data 228 may include data generated as a result of the execution of one or more modules in the other modules 220.

In one implementation, at first, a user may use the communication device 104 to access the system 102 via the I/O interface 204. The user may register themselves using the I/O interface 204 in order to use the system 102. The system 102 facilitates automatically generating a plurality of test cases for an IT enabled application. In one aspect, the user 104 may accesses the I/O interface 204 of the system 102 for automatically generating the plurality of test cases. In order to generate the plurality of test cases, the system 102 may employ the plurality of modules i.e. the UI and event capturing module 212, the UI and event analyzer module 214, the mapper module 216, the keyword mapper module 218, and the test case generator module 220. The detailed working of the plurality of modules is described below.

The UI and event capturing module 212 captures information pertaining to a plurality of Document Object Model (DOM) elements. In one aspect, the information may include a plurality of labels, a plurality of test datasets and a plurality of actions performed by a user on each of the plurality of DOM elements. The plurality of DOM elements and the plurality of labels are present on a web-page of an IT enabled application. It may be understood that the UI and event capturing module 212 captures the information from a User Interface (UI) of the IT enabled application rendered in a browser 302. Examples of the browser 302 may include, but not limited to, Chrome®, FireFox®, and Opera®. In one embodiment, the information captured by the UI and event capturing module 212 may include event type, component type, name or id, related labels (if any), and a test dataset (if any) for an action performed by the user. In one embodiment, the information, as aforementioned, may be captured by an event tracker 304, HTML DOM element tracker 306, HTML Tag attributes 308, and HTML Tag Value 310. In one aspect, the information may be captured by the UI and event capturing module 212 upon identifying and analyzing a DOM element based on the interaction of the user with the browser. In one embodiment, a start button and stop button is provided to the user in order to capture atomic units of the IT enabled application along with activities of the user for creating the test cases.

Subsequent to the capturing of the information, the UI and event analyzer module 214 analyzes the information in order to categorize the information into a plurality of parameters associated to each DOM element. The plurality of parameters may include, but not limited to, type of an event, type of the DOM element, name of the DOM element, ID of the DOM element, alert associated to the DOM object, Traversed Menu, and test case count. In one embodiment, the UI and event analyzer module 214 categorizes the information using an action analyzer 312, an element analyzer 314, a label analyzer 316, and a data analyzer 318. The action analyzer 312 determines the action to be performed on the DOM element by the user. The element analyzer 314 determines the type of the element thereby determining what action is to be performed on which element. The label analyzer 316 determines the label corresponding to the element. The data analyzer 318 determines the test data entered by the user while interacting with the DOM element. Thus, in this manner, the UI and event analyzer module 214 categorizes the information into the plurality of parameters.

Once the information is categorized, the mapper module 216 maps an action performed by the user, on the DOM element, a label and a test dataset with the DOM element. The objective of the mapper module 216 is to process the information obtained from the UI and event analyzer module 214 in order to construct different types of elements that may be used for generating the plurality of test cases. In one aspect, the processing involves analyzing and mapping of obtained details to various categories like traceability, test case, and test step, and test data via respective mapper i.e. a traceability mapper 320, test case and test step mapper 322, and test data mapper 324.

The objective of the traceability mapper 320 is to categorize and obtain the probable traceability details of the test case from the information captured. Traceability generally, means the feature and test case association. In other words, to which feature this test case belongs to. In one aspect, the element analyzer 314 is the key input which provides the details about on what type of DOM element, the action is to be performed. In one example, if the DOM element type is a ‘menu’, then the related label analyzer 316 inputs are considered as the feature to be mapped to the test case. In one aspect, the traceability information may be used in the test case generation process for grouping the test cases.

In order to elucidate the aforementioned functioning of the traceability mapper 320, consider an example, where in a public service web site of a country, a user may find menu and sub-menus like Departments/Education/University, and link such as “Find University”. These menu, sub-menu, and link are obtained as the test case name “Departments/Education/University-Find University”.

The objective of the test case and test step mapper 322 is to identify the actions corresponds to test case and test steps. In one example, the first button or link click action or a data entry or data select action performed, after one or multiple menu navigations, the first button or link click action or a data entry or data select action is considered as first test step. The test step creation is dependent upon object type and event type that may occur based on the action performed by the user. According to embodiments of the present disclosure, the system 102 maintains a preconfigured mapping between the actions that may be performed by the user on an object type and the content to be pre-populated in the test case content. Therefore, by extracting the label associated with the UI element and based upon the preconfigured mapping, the appropriate text for the test case may be generated.

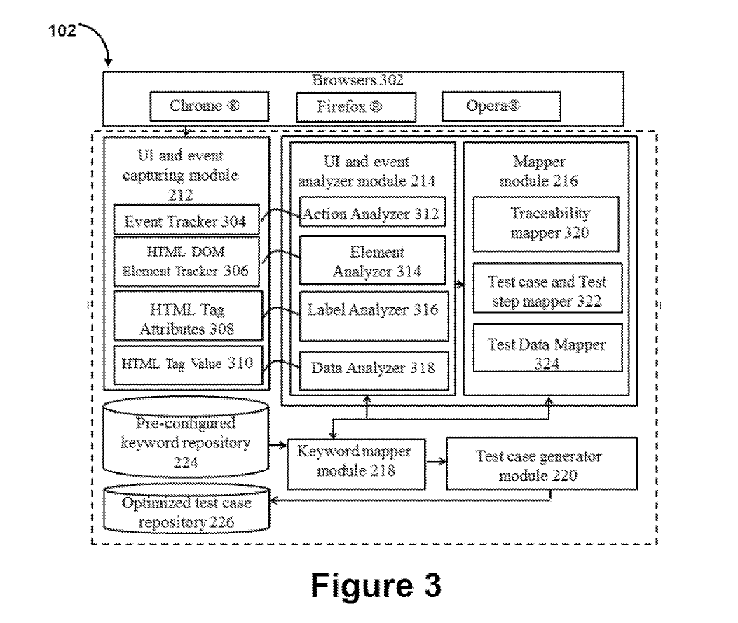

In parallel with test case and test step mapper 322, the test data mapper 324, as shown in FIG. 3, may collect the data inputted by the user and consolidates the test data. In one example, consider a test case where the user needs to input a username and select the country to which the user belongs to. In this example, there will be two steps for this test case as below which requires data input:

1. Enter Username [UN—User Name]

2. Select Country [CN—Country Name]

In the aforementioned case, when the test case scenario is performed for the very first time, At test step 1, the data analyzer 310 may provide the entered username (UN1—Step 1 Test data) to the test data mapper 324. Further, At test step 2, the data analyzer may provide the selected Country name (CN1—Step 2 Test data) to the test data mapper 324. So, the data may be consolidated at two levels as below:

Test Step level as TSD={UN=[UN1] and CN=[CN1]}, Where TSD—Test Step Data and
Test Case level as TCD={[UN1, CN1]}

Similarly, in the aforementioned case, when the test case scenario is performed for the second time, At test step 1, the data analyzer 318 may provide the entered username (UN2—Step 1 Test data) to the test data mapper 324. At test step 2, the data analyzer 318 may provide the selected Country name (CN2—Step 2 Test data) to the test data mapper 324. So, the data may be consolidated at two levels as below:

### TSD={UN=[UN1, UN2] and CN=[CN1, CN2] } and TCD={[UN1, CN1], [UN2, CN2]}

Subsequent to the mapping, the keyword mapper 218 retrieves one or more keywords mapped to the label in a pre-configured keyword repository 224. In one embodiment, the pre-configured keyword repository 224 stores mapping of the label with the one or more keywords synonymous to the label. The one or more keywords may then be retrieved from the pre-configured keyword repository 224 and used for generating the plurality of test cases.

After retrieving the one or more keywords, the test case generator module 220 generates a test case based on the one or more keywords, the label, the test dataset and the action performed by the user on the DOM element thereby automatically generating the test case for the IT enabled application. In one aspect, the logic for creating the test steps may be dependent on the DOM element and the event that is occurring based on the action performed by the user. It may be noted that there is a pre-configured map between the action performed by the user on the DOM element and the content to be prepopulated in the test case content. So extracting the label associated with the DOM element and mapping with template map, the appropriate text for the test case is generated.

Following is a an example illustrating the concept of constructing an action performed in the UI

If the element type is text box and associated label is “User Name”, then the test step is defined as “Enter User Name”. If the element type is drop-down box and associated label is “Country”, then the test step is defined as “Select Country”. The same procedure is repeated for different UI elements to define the test steps. For each test steps, the typed-in or selected data is tracked as respective test dataset. In this example, control and action mapping information like “Text Box—Enter, Dropdown box—Select etc.” may be stored in the pre-configured keyword repository 2224. The mapping information may be retrieved by the Test Case and Test Step Mapper 322 through the keyword mapper module 218. Thus, in this manner, the test case generator module 220 generates the plurality of test case. In one embodiment, the system 102 may further display an expected output pertaining to each test case generated to the user. The expected output may be displayed based on an alert, a validation message, or an error message associated to the DOM element.

In one embodiment, once the plurality of test cases is generated, the plurality of test cases may be optimized to remove redundant test cases from the plurality of test cases thereby creating a plurality of optimized test cases. The optimized test cases may be stored in an optimized test case repository 226. In one aspect, the optimized test case repository facilitates faster delivery IT enabled products or applications and optimizes the effort required from a Developer, a Business Analyst, a Functional expert, or a Manual tester while testing one or more other IT enabled application that may be developed.

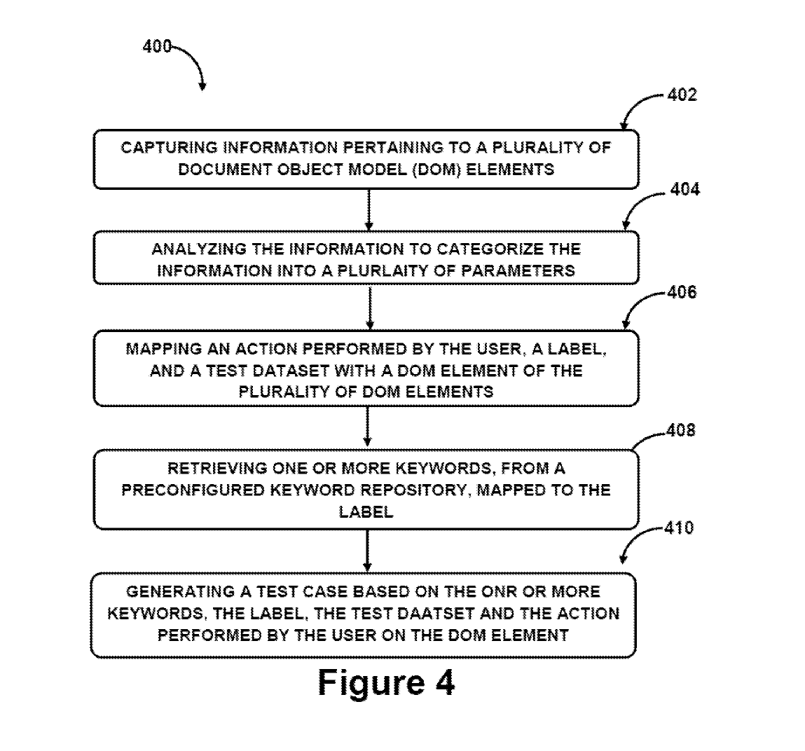

Referring now to FIG. 4, a method 400 for automatically generating a plurality of test cases for an IT enabled application is shown, in accordance with an embodiment of the present disclosure. The method 400 may be described in the general context of computer executable instructions. Generally, computer executable instructions can include routines, programs, objects, components, data structures, procedures, modules, functions, etc., that perform particular functions or implement particular abstract data types. The method 400 may be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the disclosure described herein. Furthermore, the method can be implemented in any suitable hardware, software, firmware, or combination thereof. However, for ease of explanation, in the embodiments described below, the method 400 may be considered to be implemented in the above described in the system 102.

At block 402, information, pertaining to a plurality of Document Object Model (DOM) elements, including a plurality of labels, a plurality of test datasets and a plurality of actions performed by a user on each of the plurality of DOM elements may be captured. In one aspect, the plurality of DOM elements and the plurality of labels are present on a web-page of an IT enabled application. In one implementation, the information may be captured by a UI and event capturing module 212.

At block 404, the information may be analyzed in order to categorize the information into a plurality of parameters associated to each DOM element. In one implementation, the information may be analyzed by a UI and event analyzer module 214.

At block 406, an action performed by the user, on a DOM element of the plurality of DOM elements, a label and a test dataset may be mapped with the DOM element. In one implementation, the action performed by the user, the label and the test dataset may be mapped with the DOM element by the mapper module 216.

At block 408, one or more keywords mapped to the label in a pre-configured keyword repository may be retrieved. In one implementation, the one or more keywords may be retrieved by the keyword mapper module 218.

At block 410, a test case may be generated based on the one or more keywords, the label, the test dataset and the action performed by the user on the DOM element thereby automatically generating the test case for the IT enabled application. In one implementation, the test case may be generated by the test case generator module 220.

Exemplary embodiments discussed above may provide certain advantages. Though not required to practice aspects of the disclosure, these advantages may include those provided by the following features.

Some embodiments enable a system and a method to automatically generate manual test cases to be stored in an optimized test case repository. In one aspect, the optimized test case repository facilitates faster delivery of IT enabled products or applications and optimizes the effort required from a Developer, a Business Analyst, a Functional expert, or a Manual tester.

Some embodiments enable a system and a method to create an optimized test case repository storing unique test cases that may be utilized while testing the IT enabled products or applications to be developed.

Although implementations for methods and systems for automatically generating a plurality of test cases for an IT enabled application have been described in language specific to structural features and/or methods, it is to be understood that the appended claims are not necessarily limited to the specific features or methods described. Rather, the specific features and methods are disclosed as examples of implementations for automatically generating the plurality of test cases for the IT enabled application.

We claim:

1. A method for automatically generating a plurality of test cases for an IT enabled application, the method comprising:
capturing, by a processor, information, pertaining to a plurality of Document Object Model (DOM) elements, including a plurality of labels, a plurality of test datasets and a plurality of actions performed by a user on each of the plurality of DOM elements, wherein the plurality of DOM elements and the plurality of labels are present on a web-page of an IT enabled application;
analyzing, by the processor, the information in order to categorize the information into a plurality of parameters associated to each DOM element;
mapping, by the processor, an action performed by the user, on a DOM element of the plurality of DOM elements, a label and a test dataset with the DOM element;
retrieving, by the processor, one or more keywords mapped to the label in a pre- configured keyword repository; and
generating, by the processor, a test case based on the one or more keywords, the label, the test dataset and the action performed by the user on the DOM element thereby automatically generating the test case for the IT enabled application.

2. The method of claim 1, wherein the plurality of parameters comprise type of an event, type of the DOM element, name of the DOM element, ID of the DOM element, alert associated to the DOM object, Traversed Menu, and test case count.

3. The method of claim 1, wherein an expected output pertaining to the test case generated is displayed to the user based on an alert, a validation message, or an error message associated to the DOM element.

4. The method of claim 1, wherein the plurality of test cases generated are optimized to remove redundant test cases from the plurality of test cases thereby creating a plurality of optimized test cases, wherein the optimized test cases are stored in an optimized test case repository.

5. A system for automatically generating a plurality of test cases for an IT enabled application, the system comprising:
a processor; and
a memory coupled to the processor, wherein the processor is capable of executing a plurality of modules stored in the memory, and wherein the plurality of modules comprising:
a UI and event capturing module for capturing information, pertaining to a plurality of Document Object Model (DOM) elements, including a plurality of labels, a plurality of test datasets and a plurality of actions performed by a user on each of the plurality of DOM elements, wherein the plurality of DOM elements and the plurality of labels are present on a web-page of an IT enabled application;
a UI and event analyzer module for analyzing the information in order to categorize the information into a plurality of parameters associated to each DOM element;
a mapper module for mapping an action performed by the user, on a DOM element of the plurality of DOM elements, a label and a test dataset with the DOM element;
a keyword mapper module for retrieving one or more keywords mapped to the label in a pre-configured keyword repository; and
a test case generator module for generating a test case based on the one or more keywords, the label, the test dataset and the action performed by the user on the DOM element thereby automatically generating the test case for the IT enabled application.

6. The system of claim 5, wherein the plurality of parameters comprise type of an event, type of the DOM element, name of the DOM element, ID of the DOM element, alert associated to the DOM object, Traversed Menu, and test case count.

7. The system of claim 5, wherein an expected output pertaining to the test case generated is displayed to the user based on an alert, a validation message, or an error message associated to the DOM element.

8. The system of claim 5, wherein the plurality of test cases generated are optimized to remove redundant test cases from the plurality of test cases thereby creating a plurality of optimized test cases, wherein the optimized test cases are stored in an optimized test case repository.

9. A non-transitory computer readable medium embodying a program executable in a computing device for automatically generating a plurality of test cases for an IT enabled application, the program comprising a program code:
a program code for capturing information, pertaining to a plurality of Document Object Model (DOM) elements, including a plurality of labels, a plurality of test datasets and a plurality of actions performed by a user on each of the plurality of DOM elements, wherein the plurality of DOM elements and the plurality of labels are present on a web-page of an IT enabled application;
a program code for analyzing the information in order to categorize the information into a plurality of parameters associated to each DOM element;
a program code for mapping an action performed by the user, on a DOM element of the plurality of DOM elements, a label and a test dataset with the DOM element;
a program code for retrieving one or more keywords mapped to the label in a pre-configured keyword repository; and
a program code for generating a test case based on the one or more keywords, the label, the test dataset and the action performed by the user on the DOM element thereby automatically generating the test case for the IT enabled application.
